(19) United States
(12) Patent Application Publication
(10) Pub. No.: US 2013/0236778 A1
(43) Pub. Date: Sep. 12, 2013

(54) ELECTRODE BINDING MATERIAL WITH Li, Na, K SUBSTITUTED FOR POLYACRYLIC ACID FUNCTIONAL GROUP (COOH) AND A LITHIUM SECONDARY BATTERY USING THE SAME

(71) Applicants: Byung Hyun Choi, Seoul (KR); Mi Jung Ji, Gwangmyeong-si (KR); Sung Hun Jung, Seoul (KR); Eun Kyung Kim, Incheon (KR)

(72) Inventors: Byung Hyun Choi, Seoul (KR); Mi Jung Ji, Gwangmyeong-si (KR); Sung Hun Jung, Seoul (KR); Eun Kyung Kim, Incheon (KR)

(21) Appl. No.: 13/679,040

(22) Filed: Nov. 16, 2012

(30) Foreign Application Priority Data
Mar. 12, 2012 (KR) 10-2012-0025118

(51) Int. Cl. H01M 4/62

(52) U.S. Cl. CPC H01M 4/622
USPC 429/211; 252/519.2

(57) ABSTRACT

The present invention is based on an electrode binding material including polyacrylics and a functional group substituent(Li, Na, K) as a binder of an electrode. The present invention provides a polyacrylic acid an electrode binding material including a polyacrylics mixture having a high degree of polymerization and a functional group with Li, Na or K being substituted and high efficiency Lithium secondary battery utilizing a silicon anode active material etc. using the same. Therefore, the electrode binding material of the present invention has an excellent binding force, and can reduce side reactions in reactions of a secondary battery, and maintain a stable cycle property, and also enhance electric performance.

### CROSS-REFERENCE TO RELATED APPLICATION

This application claims the benefit of Korean Patent Application No. 10-2012-0025118 filed on Mar. 12, 2012, which is herein incorporated by reference as if fully set forth herein.

### BACKGROUND OF THE INVENTION

The present invention relates to an electrode binding material with Li, Na, K substituted for a functional group having a high degree of polymerization and a lithium secondary battery using the same.

Lithium ion batteries require securing their performance with high capacity and low cost as well as—stability in order to be applied to various, applications such as electric vehicles and energy storage devices. Furthermore, the lithium ion batteries need to have a smaller volume and a high energy density. It is anticipated that the usage of electric vehicles and batteries for energy storage will increase rapidly from now on, therefore electric vehicles and batteries for energy storage require securing a competitive price against existing lithium ion batteries, and also require excellent cathode materials(Li₂MnO₃) and anode materials with high capacity, high output and high stability. In particular, in case of anode materials, it is necessary to develop metal oxide anode materials, such as silicon or tin etc. which is more excellent than graphite materials in storing electricity.

In recent, Si materials in anode have both a crystalline form and a noncrystalline form. Noncrystalline is more suitable for anodes among electrode materials including Si materials. In addition, microcrystal silicon materials can be used as anode materials. Microcrystalline is a form between a crystalline form and a noncrystalline form. During the process of charge and discharge, lithium ions may be intercalated and de-intercalated with Si materials. When lithium ions are intercalated with Si materials, they can form an alloy with silicon materials. In addition, they can provide a high specific capacity for batteries. Theoretical capacity is about 4,200 mAh/g and practical applicable capacity is about 2,000 mAh/g.

However, there is an urgent problem to solve in Si materials. It is that during the process of the charge and discharge, i.e., when reactions of the battery begin, the range of variation in Si volume may be very large due to the intercalation and de-intercalation of lithium ions. For example, the volume of Si materials can increase to 10 times than the original size after intercalation of lithium ions. The volume variation may cause a series of problems. For example, anode materials may be destroyed and broken during the charge and discharge cycle, and the ability capable of intercalating and de-intercalating lithium may be lost. In addition, the performance of batteries may be degraded due to peeling and deformation of anode materials from a electric collector. A binder is used as an important element of an anode. The binder is used to fix particles of materials together and stick the particles on an electric collector. The binder can prohibit materials of anode active materials from being destroyed and broken.

Therefore, the performance of an electrode is determined to some extent depending on a type of the binder. As of now, conventional electrode binding materials are Styrene-Butadiene Rubber(SBR) polymer. For example, Polyvinylidene difluoride(PVDF) having a good binding force has been generally used as an anode binder. However, it may expand in most of organic electrolytes such as propylene carbonate, dimethoxyethene. In addition, after the expansion, its binding force become low, thereby it has substantial room for breaking a microstructure of the anode materials. Therefore, the PVDF may have a negative influence on the performance of batteries. While SBR being a water-borne binder has an excellent elasticity force, it has a lower adhesive force. Therefore, it results in bad cycle efficiency and bad life maintenance properties.

It is found that Si, Sn or Si alloy etc. have 5˜10 times than graphite being main anode material in theoretical capacity. However, it has drawbacks that it is difficult to secure a cycle life by destruction of structure since the variation of volume is 100˜400% due to intercalation-de-intercalation of Li ions. Therefore, the present inventor devised a binder capable of controlling expansions and maintaining high capacity for a long time in order to solve the problem. In particular, the present inventor devised a binder suitable for silicon based electrodes.

### SUMMARY OF THE INVENTION

Therefore, the present invention is based on an electrode binding material including polyacrylics and a functional group substituent(Li, Na, K) as a binder of an electrode. The present invention provides a polyacrylic acid as an electrode binding material including a polyacrylics mixture having a high degree of polymerization and a functional group with Li, Na or K substituted and high efficiency Lithium secondary battery utilizing a silicon anode active material etc. using the same. Therefore, the electrode binding material of the present invention has an excellent binding force, and can reduce side reactions in reactions of a secondary battery, and maintain a stable cycle property, and also enhance electric performance.

According to an aspect of the present invention, an electrode binding material including an electrode active material is provided, the electrode binding material comprises a binder comprising polyacrylics mixture having a functional group(hereinafter, R) with at least one of Li, Na and K substituted in a polyacrylic acid having 13,000˜18,000 degree of polymerization.

Advantageously, said polyacrylics mixture further comprises a first polymer, a second polymer, a third polymer and a fourth polymer, wherein said first polymer comprises a polyacrylic acid having a hydroxyl functional group, said second polymer comprises polyacrylics having R═Li⁺, said third polymer comprises at least one of a monomer selected from a group consisting of R═Na⁺ in said first polymer, and said fourth polymer comprises at least one of a material selected from a group consisting of polyacrylics having at least one of a monomer consisting of R═K⁺ in said first polymer and a combination of said polyacrylics.

Advantageously, wherein the molecular weight of said polyacrylic acid is 1,000,000˜1,250,000.

Advantageously, said polyacrylics mixture is a high molecule polymer having R including at least one of Li, Na and K, and said polyacrylics mixture is 0.1˜100 part by weight on the basis of 100 part by weight of said polyacrylic acid.

Advantageously, said binder is 3˜10 weight % on the basis of total weight of said electrode binding material.

Advantageously, said polyacrylics mixture being a high molecule polymer having the functional group(R) including at least one of Li, Na and K is an aqueous solution including a hydroxyl group, and said aqueous solution of said polyacrylics mixture is 0.1˜100 weight % on the basis of total material weight.

According to another aspect of the present invention, an electrode for a secondary battery comprising an electric collector is provided, wherein said electric collector is coated with the above electrode binding materials. Advantageously, said electrode is silicon anode.

According to another aspect of the present invention, a lithium secondary battery comprising the above electrode.

As stated above, the present invention is based on an electrode binding material including polyacrylics and a functional group substituent(Li, Na, K) as a binder of an electrode. Therefore, the present invention can maintain excellent properties and enhance properties in electrode active materials showing reductions of life cycle and electro-chemical capacity during the progress of charge and discharge, and can suppress side reactions during charge and discharge, and during the reaction, substituents such as Li for decomposed materials are produced by additional electric reactions. Thus, the present invention has effects that can enhance a design capacity and provide an enhanced life cycle, thereby contribute to the enhancement of battery properties.

### BRIEF DESCRIPTION OF THE DRAWINGS

FIG. 1 is a graph representing the cycle property variation of a lithium secondary battery fabricated by using a polyacrylic acid solution (except substituents) in the preparation example 1 of the present invention.

FIG. 2 is a graph representing the cycle property variation of a lithium secondary battery according to example 1 of the present invention.

FIG. 3 is a graph representing the cycle property variation of a lithium secondary battery according to example 2 of the present invention.

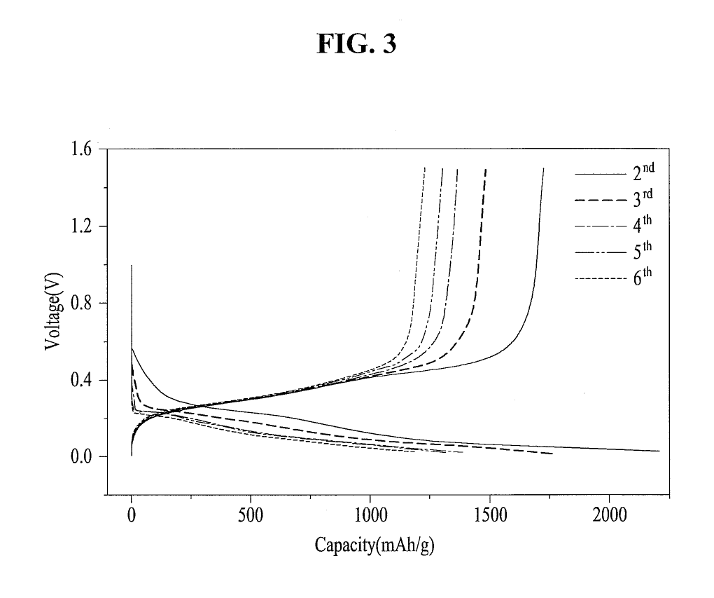

FIG. 4 is a graph representing the cycle property variation of a lithium secondary battery according to example 3 of the present invention.

### DETAILED DESCRIPTION OF THE INVENTION

In the following detailed description, the most desirable embodiments of the present disclosure are described in detail, with reference to attached figures, in order to enable an ordinary person skilled in the art to implement the present invention.

The present invention relates to an electrode binding material for a secondary battery with its anode material being silicon(Si), and is consisted of a mixture including a polyacrylic acid having 13,000˜18,000 degree of polymerization(molecular weight, 1,000,000˜1,250,000).

In the electrode binding according to the present invention, the polyacrylics mixture where the polyacrylic acid or polyacrylic acid and polyacrylics substituents are mixed, wherein these have a high degree of polymerization and a high molecular weight, provide an excellent persistency rate of cycle life and an enhanced charge and discharge capacity for silicon based material being an active material having an high decreasing rate in cycle life(the persistency rate of capacity) during the progress of charge and discharge in particular, by its high binding capacity and a combination of elements reducing productions of side reactions during electro-chemical reactions, and a lithium polyacrylics binding material with Li+ ion substituted in polyacrylics being another element shows an effect that side reactions with an anode according to organic matter decomposition decrease when adding Li being a main reactant and using an electrolyte, thereby in particular enhances the electric capacity.

In this regard, basic properties of matter of the polyacrylic acid and polyacrylics are known, but it is found that enhanced properties more than properties of matter expected conventionally can be obtained by the binder consisted of combinations of these, as can be found in following examples.

Therefore, when the electrode binding material according to the present invention is applied to a secondary battery, its properties can be persisted excellently and enhanced in electrode active materials showing decrease of cycle life and decrease of an electro-chemical capacity during charge and discharge, thereby side reactions during charge and discharge are suppressed and substituents such as Li for decomposed materials are formed by additional electric reactions, thereby the electrode binding material according to the present invention can provide an enhanced cycle life and increase of a design capacity of batteries, thereby can contribute to the enhancement of properties of batteries.

One of important characteristics of the present invention is that the present invention uses a high molecule polyacrylic acid and polyacrylics which have higher molecular weight than conventional materials and are synthesized by much simpler synthesis method than conventional methods.

In this regard, the polyacrylic acid is coated on copper foils uniformly as an electrode active material as well as an electric collector of an electrode by carboxyl groups formed repeatedly in high molecule chains. In addition, the polyacrylic acid enhances adhesion between the electrode binding material and the electric collector, and shows an excellent adhesive strength. Therefore, the electrode active material can be adhered to the surface of the electric collector by adding only small amount relatively. In addition, according as the charge and discharge cycle of batteries progresses, the electric active material is prohibited from breaking away on the surface of the electric collector, thereby it can provide a higher battery capacity relatively and an excellent cycle property. Moreover, the polyacrylic acid has higher electrical conductivity than others, and thus the electric resistance becomes noticeably low as compared to the same content within the electrode, thereby it shows excellent and a high efficient charge and discharge property.

In addition, the polyacrylics mixture is a high molecule polymer having a functional group(R) including at least one of Li, Na and K. The high molecule polymer is a binder of an electrode and can increase elasticity and binding strength, and it can reduce a short of an anode or a peeling phenomenon by those reactions, thereby it can enhance the cycle life.

Advantageously, the degree of polymerization(DP) of the polyacrylic acid is 13,000˜18,000. More advantageously, the DP of the polyacrylic acid is 15,000˜16,000. In case of DP under 13,000, the binding strength with the electric collector is not enough, thereby the electric active material is peeled from the electric collector, thereby it may cause the charge and discharge capacity to fall rapidly. On the contrary, in case of DP over 18,000, the polyacrylic acid may increase the resistance of an electrode, and it has a high viscosity excessively and form gel easily in a solvent by a strong hydrogen bond, and consequently make the fabrication process of an electrode be difficult. In addition, advantageously, the molecular weight of the polyacrylic acid is 1,000,000˜1,250, 000.

Advantageously, the polyacrylics mixture which are a binder of an electrode and can enhance the elasticity and the binding strength further comprises a first polymer, a second polymer, a third polymer and a fourth polymer, wherein said first polymer comprises a polyacrylic acid monomer having R═OH, said second polymer comprises polyacrylics having R═Li⁺, said third polymer comprises at least one of a monomer selected from a group consisting of R═Na⁺ in said first polymer, and said fourth polymer comprises one or more than two of a material selected from a group consisting of polyacrylics having at least one of a monomer consisting of R═K⁺ in said first polymer and a combination of said polyacrylics.

The first polymer may be any polymer containing a proper hydroxyl group. In this regard, the polymer comprises a monomer containing a hydroxyl group. The monomer containing a hydroxyl group may comprise carbonate anions temporarily, but this contain is by a momentary ionic migration and main group is a polymer of a monomer containing a hydroxyl group, or main group may be selected from a group consisting of a combination of the polymer of a monomer containing a hydroxyl group. Advantageously, the polymer containing a hydroxyl group is selected from a group consisting of a combination of a polymer connected with only monomers. The second polymer, the third polymer and the fourth polymer may further comprise a polymer having a functional group. In this regard, ‘functional group’ means a group defined as a functional group in chemical such as a group including hydroxyl group, hydrogen(H), lithium(Li), sodium(Na) or potassium(K). Advantageously, the functional group in the present invention is a carboxyl group or a carbonate group and a carboxylic acid. The carboxyl group or the carbonate group and the carboxylic acid form a hydrogen bond with —OH group(hydroxyl group) in a solution, in particular, oxygen in —OH(hydroxyl group) and hydrogen in the carboxylic acid and the carbonate group, or hydrogen in —OH and the carboxyl acid and oxygen in the carbonate form hydrogen bonds mutually, thereby it can enhance elasticity and bonding strength as a binder of an electrode, and thus phenomena such as a short and peeling of an anode by those reactions can be reduced, thereby the cycle life can be enhanced.

On the other hand, the second polymer is any proper polymer different from the first polymer, the third polymer or the fourth polymer. When an electrode in a secondary battery acts as a battery, and when a decomposition reaction of the electrolyte occurs by using an improper organic electrolyte which may be produced by an electro-chemical reaction, or when the decomposition of materials occurs differently, wherein the materials participates in electro-chemical reactions of elements of the secondary battery, a polyacrylic acid consisting of a polymer and a monomer containing a hydroxyl group in the second polymer and a polymer containing a hydroxyl group are substitution-reacted at the mole rate of 1:1, and the above discomposed products is reacted with Li+ ions in a polyacrylics binding material with Li+ substituted for the functional group, and the reaction of the discomposed products with the substituent functional group of the binder is induced, and therefore according to process of a cycle, Li source increases. Therefore, conventional shortcomings that oxidation is processed and Li source is reduced gradually according to increasing of the number of cycles can be overcome.

Moreover, although the discomposed products is on the other hand not reacted with the substituent functional group of the binder, consequently Li metal substituted in the binder excesses Li source in the electro-chemical reaction, thereby the enhancement of the cycle life and the capacity by Li can be obtained.

From another point of view, the cycle life and the charge and discharge capacity are related each other. In other words, the enhancement of the cycle life means that there is an anode capable of processing the charge and discharge, i.e., capable of reacting electrically. And also, the present effects are added to a basic capacity of active materials of the anode in the initial capacity. Of course, when the initial capacity is very large like that of silicon, according to processing of charge and discharge, the persistency rate of capacity is better than that of a conventional battery and furthermore is superior to any other batter.

On the other hand, the binder is contained 3˜10 part by weight on the basis of total weight of the electrode binding material(more advantageously, 5˜8 part by weight), and advantageously, the polyacrylics mixture which is a high molecular polymer having a functional group(R) including Li, Na, K in the binder is mixed a content of 0.1˜100 part by weight(more advantageously, 1˜50 part by weight) for 100 part by weight of the polyacrylic acid.

In addition, the polyacrylics mixture is a high molecule polymer having a functional group(R) including Li, Na, K. Advantageously, it may be contained 0.1˜100 part by weight on the basis of 100 part by weight of the polyacrylic acid.

The electrode binding material is an electrode active material besides the binder. In this regard, although it may be applied as an active material for an anode as an electrode active material, it is more advantageous that it is applied to anode active materials with a high volume variation.

In this regard, it is the most advantageous in the case that silicon based active materials having limits to applying as a real active material due to a large volume is used.

The silicon anode active material may include a silicon(Si) particle, a silicon-carbon complex etc.

In addition, the electrode binding material according to the present invention selectively further comprise a viscosity control agent, a conductive agent, a filling agent, a coupling agent, an adhesion facilitator etc. or a combination of more than two of them, besides the electrode active material and the mixture binder.

The viscosity control agent is a component controlling the viscosity of the electrode binding material to facilitate an applying process on its electric collector and a mixing process of the electrode binding material. In this regard, the viscosity control agent may be added to 30 weight% on the basis of total weight of the electrode binding material. For example, the viscosity control agent may be carboxymethyl cellulose, polyvinylidenfluoride etc., but not limited to these. In some cases, the above-mentioned solution may act as the viscosity agent.

The conductive agent is a component more improving the conductivity of the electrode active material. It may be added to 1˜20 weight % on the basis of total weight of the electrode binding material. The conductive agent may be anything as long as it does not induce any chemical variations in a pertinent battery while it has conductivity. For example, the conductive agent may be graphites(for example, a natural graphite or an artificial graphite etc.), carbon blacks(for example, carbon black, acetylene black, ketjen black, channel black, furnace black, lamp black, summer black etc.), conductive fibers(for example, a carbon fiber or a metal fiber etc.), metal powders(for example, fluorocarbon, aluminum, nickel powder etc.), conductive whiskeys(for example, zinc oxide, potassium titanate etc.), conductive metal oxides(for example, titanium oxide etc.), conductive materials(for example, polyphenylene derivatives etc.).

The filling agent is an assistant component restraining an expansion of the electrode. The filling agent may be anything as long as it does not induce any chemical variations in a pertinent battery while being a fibrous material. For example, the filling agent may be olefin polymers(for example, polyethylene, polypropylene etc.), fibrous materials(for example, glass fiber, carbon fiber etc.)

The coupling agent is an assistant component increasing bonding strength between the electrode active material and the binder. It is characterized by having more than two of functional groups, and may be used to 30 weight % on the basis of binding weight. For example, the coupling agent may be materials that one functional group forms a chemical union by reactions with a carboxyl group or hydroxyl group of the surface of silicon, tin, or graphite active materials, while another functional group forms a chemical union by reactions with a high molecule binder. For example, the coupling agent may be silane coupling agents such as triethoxysilylpropyl, mercaptopropyl triethoxysilane, aminopropyl triethoxysilane, chloropropyl triethoxysilane, vinyl triethoxysilane, methacryloxypropyl triethoxysilane, glycidoxypropyl triethoxysilane, isocyanatopropyl triethoxysilane, cyanatopropyl triethoxysilane etc.

The adhesive facilitator is an assistant component improving bonding strength of the active material for the electric collector. It may be added to 10 weight % on the basis of the binder. For example, the adhesive facilitator may be oxalic acid, adipic acid, formic acid, acrylic acid derivatives, itaconic acid derivatives etc.

Furthermore, the present invention provides a electrode for a secondary battery being coated with the electrode binding material on the electric collector. In this regard, in order to improve the adhesiveness between the electrode binding material and the electric collector, a conductive adhesive may be in-between.

The electric collector in the electrode according to the present invention is a part that reactions of ion migration are occurred in the electro-chemical reaction of the active material. Although there are an anode electric collector and a cathode electric collector according to a type of electrode, herein the anode electric collector is only represented.

The anode collector is generally fabricated with the thickness of 3˜500 um. The anode collector may be anything as long as it does not induce chemical variations in a pertinent battery while having conductivity. For example, the anode collector may be made of Cu, stainless steel, aluminum, nickel, titanium, baked carbon, or materials of which the surface(for example, the surface of Cu or stainless steel) is treated with carbon, nickel, titanium, silver etc., or aluminum-cadmium alloy.

The anode electrode collector may comprise a concavo-convex structure that is formed on its surface, thereby the concavo-convex structure may enhance the bonding strength of the electrode active material, and it may be used as various type such as films, sheets, foils, nets, porous bodies, foamed bodies, non-woven bodies etc.

The anode for a secondary battery may be fabricated by coating the electrode binding material on the electric collector, wherein the electrode binding material is prepared by mixing the anode active material and binder with selectively the conductive agent and the filling agent etc. For example, it may be fabricated by dissolving the electrode binding material containing polyacrylics substituent complex at the rate of 1 weight %˜10 weight % in a solvent, and adding the electrode active material, selectively the conductive agent, the filling agent etc. in the solvent to become slurries, and then coating it on the electric collector of metal foils etc., and then drying and pressing it.

Advantageously, the solvent used in fabrication of the electrode slurry may be organic solvents such as dimethyl sulfoxide(DMSO), N-methyl pyrrolidon(NMP) etc., but not limited to the above.

The dry process after the coating on the electric collector is may be performed at a temperature of below 200° C., more advantageously, below 150° C. The effect as the binder cannot be anticipated since the polyacrylic acid is decomposed rapidly at a temperature above 200° C.

Moreover, the present invention provides a lithium secondary battery comprising the anode. The lithium secondary battery in the present invention may be fabricated with a conventional method. Generally, a separator is located between a cathode and an anode, thereby it forms a cell core. The cell core may be located in a battery cover, and an electrolyte is injected into the cover and then sealed by a sealing apparatus to provide the lithium secondary battery.

### EXAMPLES

Hereinafter, the present invention is described in detail with the below preparation examples, but the present invent is not limited to these.

### Preparation Example 1

The present inventor put 100 g of distilled water into 200 ml of a 3× joint neck reaction flask with a mantle fabricated with a cloth, wherein the mantle can sustain heating under polyacrylic acid powder(Mw 450,000˜1,250,000, Tg 80˜106.0, 99.9%, SIGMA-ALDRICH, Co.), Li source(LiOH.H2O (monohydrate), 95%, DAEJUNG CHEMICALS & METAL Co., LTD.), K source(KOH, 85%, DAEJUNG CHEMICALS & METAL Co., LTD.), Na source(NaOH, 95%, DAEJUNG CHEMICALS & METAL Co., LTD.), and then persisted 50° C., and then put 15 weight % of the polyacrylic acid, and then consistently stirred at 200 rpm for more than 12 hours. The weight % of the polyacrylic acid solution is a value that is obtained from the solid content test(NVM Test), in particular, after drying 120 hot air drying for more than 10 hours and then implementing NVM Test.

### Example 1

The present inventor drew off proper weight from 15 weight % of the polyacrylic acid solution prepared by the preparation example 1, and then calculated the mol number of a monomer(56g/mol) of the polyacrylic acid for the proper weight, and then prepared a substituent at the same rate of the mol number, i.e., at the rate of quantitative 1:1 mol. In this regard, the present inventor prepared the substituent at 200 rpm of the stirring speed and at a temperature of 80° C. and consistently stirred for more than 8 hours. In addition, Li source is prepared to use as a type of a solution solved in distilled water.

### Example 2

The present inventor prepared the substituent in the same method excluding Na source instead of Li source at the quantitative mol rate.

### Example 3

The present inventor prepared the substituent in the same method excluding K source instead of Li source at the quantitative mol rate.

### Example 4

### The Fabrication of Si Anode

The present inventor prepared a mixture by adding Silicon power(30-50 nm, 99% purity, 70-80 m2/g SSA, Nanostructured & Amorphous Materials Inc.) and the above first, second, third and fourth polymer binder in a glue solution at 9:1 of the rate of weight respectively. Then, the present inventor mixed the mixture with a high speed mixture for 20 minutes. For example, the max rpm of the mixture may be 2000. Then, the present inventor prepared uniform slurries by processing a defoamation for 1-2 minutes. Then, the slurries are uniformly coated on a Cu foil, i.e. an electric collector. Then, the present inventor dried the coated foil in a heated-air drier for 1 hour, and then carried out a rolling process for it. Then, the present inventor made its upper plate and lower plate to be 50° C., and then carried out a rolling process. The rate of the rolling process may be 10˜30%, and therefore the thickness of the fabricated electrode may be 40˜65. Then, the present inventor dried the fabricated electrode at a temperature of 120° C. in a vacuum oven for more than 12 hours.

### Example 5

The present inventor perforated the anode plate fabricated in the example 4 in a circular shape with its surface being 1.37 cm² to be an acting pole. Then, the present inventor fabricated a coin type of half cell with a metal lithium foil perforated in a circular shape with its surface being 1.41 cm² as a whole foil. The present inventor interposed a separator between an acting pole and an opposite pole, and then put an electrolyte solution that was prepared by dissolving LiPF6 electrolyte at a concentration of 1M using the ½ mixed solvent of EC(ethyl carbonate):EMC(ethyl-methyl carbonate) to complete a lithium secondary battery.

### Experimental Example 1

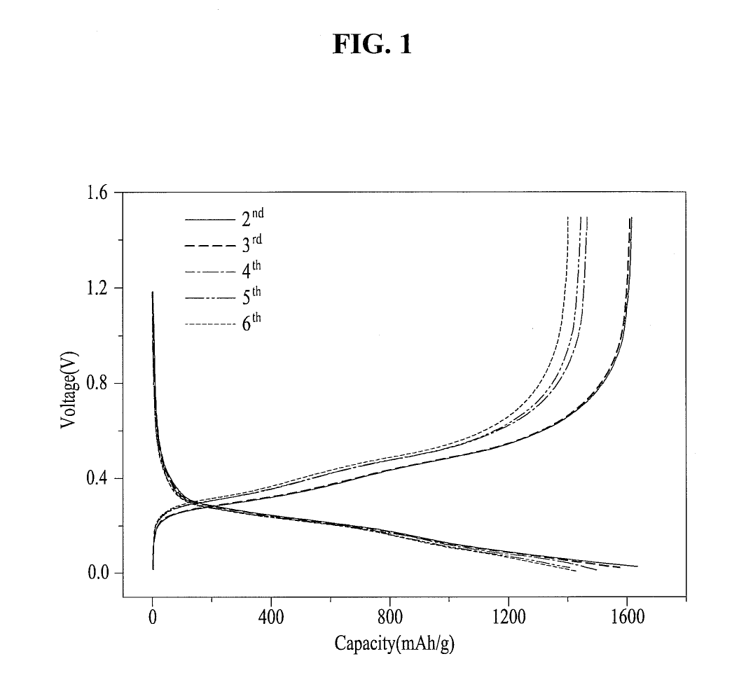

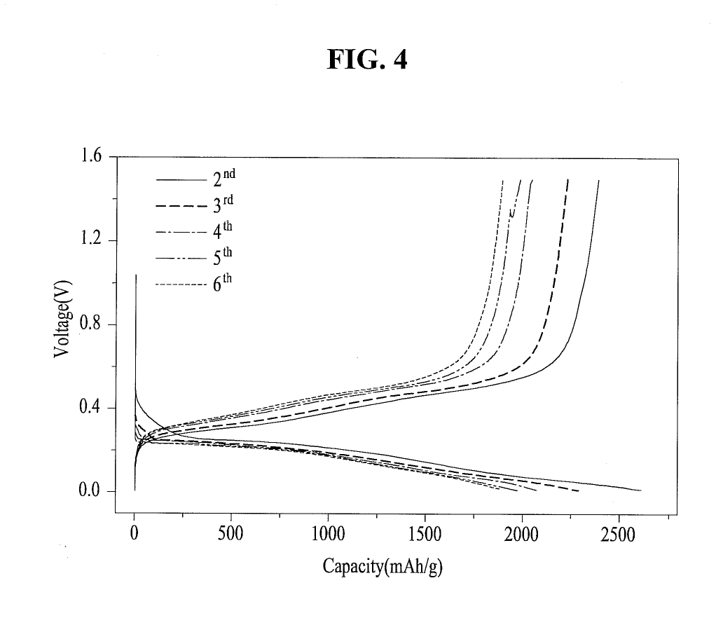

To evaluate the performance of a coin type battery, the present inventor repeated one cycle with 0.05° C. constant current/constant voltage, another cycle with 0.1° C. constant current/constant voltage, and fifty cycles with 0.5° C. constant current/constant voltage for the fabricated batteries in the example 5. Then, the present inventor represented to compare their initial capacity and initial efficiency, and an efficiency after the cycles by graphs of FIG. 1˜FIG. 4 representing cycle property variations respectively.

After the present inventor evaluated by fabricating more than five coin type batteries for the same binder composite(refer to FIG. 1˜FIG. 4), determined with mean values. The result is described in below table 1.

TABLE 1

| | | Initial | Capacity | Capacity | Capacity |
|---|---|---|---|---|---|
| | Initial | effi- | after 10 | after 50 | after 100 |
| | capacity | ciency | cycles | cycles | cycles |
| | (mAh/g) | (%) | (mAh/g) | (mAh/g) | (mAh/g) |
| First | 1610 | 84 | 944 | 556 | short |
| polymer(OH) | | | | | |
| Second | 5717 | 91 | 4141 | 3190 | 2464 |
| polymer(Li) | | | | | |
| Third | 2211 | 85 | 974 | 503 | short |
| polymer(Na) | | | | | |
| Fourth | 2752 | 88 | 1289 | 850 | 488 |
| polymer(K) | | | | | |
| Poly | 2992 | 84 | 1289 | short | short |
| vinylalcohol | | | | | |

As can be seen in the table 1 and FIG. 1˜FIG. 4, overall, the battery of the example 5 using the second, the third and the fourth polymers shows more excellent efficiency than that of a battery in examples using the polyacrylic acid as a binder. In particular, in case of using a polymer binder(the second polymer) with Li source substituted in the polyacrylic acid, batteries fabricated by using the binder made of the second polymer of the preparation 1 and the example 1 showed the most excellent capacity, as the polyacrylic acid compared with other substituents-binder. Above all, a result exceeding the theoretical capacity of silicon is shown in the second polymer. The reason is that substituted lithium is added excessively. Moreover, according to the progress of cycles, differences in capacity per binder were shown, after 100 cycles, the second polymer also showed excellent battery properties with the highest capacity of 4000 mAh/g.

Also, the result of comparison of graphs representing cycle property variations of FIG. 1˜FIG. 4 is described as below.

First, referring to the charge—discharge of the polyacrylic acid, when progressing charge·discharge at the temperature of 0.5° C., in case of polyacrylic acid, capacity was measured as 1610 mAh/g and discharge was 1344 mAh/g in the initial capacity, and batteries were fabricated at the degree of polymerization of polyvinylalcohol optimized in previous studies. In terms of only the initial efficiency, it is higher as compared to other substituent binder since cycles progressed at a relatively lower capacity. Since the substituent binder discharged after charging at a higher capacity than the polyacrylic acid binder, its initial efficiency is not high by that. However, in terms of the long-lived property, the decreasing rate of polyacrylic acid is higher than others. Under this results, the present inventor fabricated binders that has an more excellent life property and is a higher capacity as compared to conventional water-borne binders, and then compared properties.

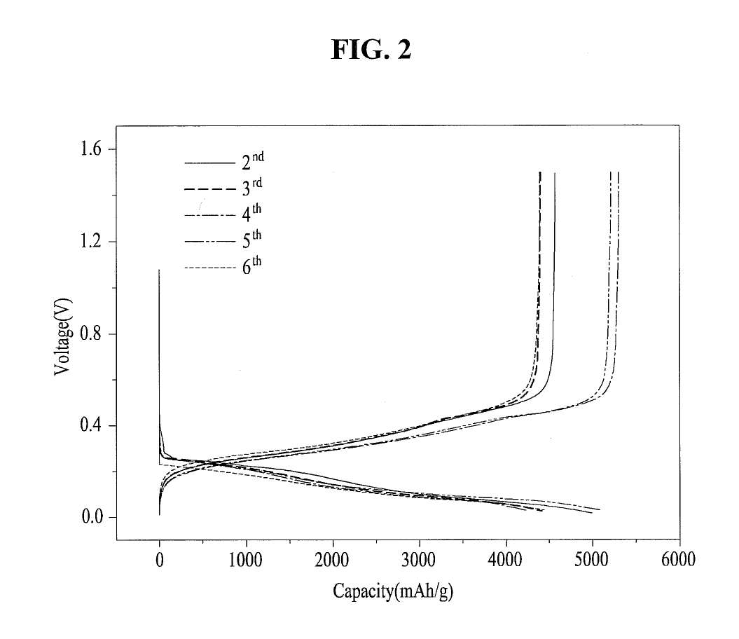

As comparing the above-mentioned comparison group, a group with Li, Na, K substituted, FIG. 2 shows the most high initial efficiency(91%) and initial capacity(5717 mAh/g) in the second polymer with Li substituted. It shows 4141 mAh/g after 10 cycles, and 3190 mAh/g after 50 cycles. Further it retains a high capacity of 2464 mAh/g being long-lived property after 100 cycles. In view of types of graphs, the second polymer with Li substituted retains flatter type between 0.2˜0.4V voltage as compared to other polymers. The third polymer and the fourth polymer with Na and K substituted has a little more excellent capacity and life properties as compared to the comparison group, i.e., polyacrylic acid. The third polymer with Na substituted is smaller in the initial capacity as compared to other substituent binders. As stated above, it shows not good results since it forms a fatal salt such NaCl in batteries according to progress of the charge and discharge.

As stated above, while the present invention is described in detail by desirable embodiments, it is only description for illustrating the present invention, but the present invention is not limited to these. A skilled person in the art can alter and modify the present invention variously within the spirit and scope of the invention, but it also falls within the invention.

1. An electrode binding material for a secondary battery including an electrode active material, the electrode binding material comprising:
a binder comprising polyacrylics mixture having a functional group(hereinafter, R) with at least one of Li, Na and K being substituted in a polyacrylic acid having 13,000˜18,000 degree of polymerization.

2. The electrode binding material of claim 1, wherein said polyacrylics mixture further comprises a first polymer, a second polymer, a third polymer and a fourth polymer, wherein said first polymer comprises a polyacrylic acid having R═OH, said second polymer comprises polyacrylics having R═Li⁺, said third polymer comprises at least one of a monomer selected from a group consisting of R═Na⁺ in said first polymer, and said fourth polymer comprises at least one of a material selected from a group consisting of polyacrylics having at least one of a monomer consisting of R═K⁺ in said first polymer and a combination of said polyacrylics.

3. The electrode binding material of claim 1, wherein the molecular weight of said polyacrylic acid is 1,000,000˜1,250,000.

4. The electrode binding material of claim 1, wherein said polyacrylics mixture is a high molecule polymer having R including at least one of Li, Na and K, and said polyacrylics mixture is 0.1˜100 part by weight on the basis of 100 part by weight of said polyaclylic acid.

5. The electrode binding material of claim 1, wherein said binder is 3˜10 weight % on the basis of total weight of said electrode binding material.

6. The electrode binding material of claim 4, wherein said polyacrylics mixture being a high molecule polymer having the functional group(R) including at least one of Li, Na and K is an aqueous solution including a hydroxyl group, and said aqueous solution of said polyacrylics mixture is 0.1˜100 weight % on the basis of total material weight.

7. An electrode for a secondary battery comprising an electric collector, wherein said electric collector is coated with an electrode binding material according to claim 1.

8. The electrode for a secondary battery of claim 7, wherein said electrode is silicon anode.

9. A Lithium secondary battery comprising the electrode according to claim 8.
